(19) United States
(12) Patent Application Publication
(10) Pub. No.: US 2014/0168998 A1
(43) Pub. Date: Jun. 19, 2014

(54) LENS STRUCTURE OF A LIGHT EMITTING DIODE

(71) Applicants: LEDLINK OPTICS, INC., New Taipei City (TW); LEDLINK OPTICS (DONG GUAN) CO., LTD., Guangdong (CN); YANG ZHOU LEDLINK OPTICS CO., LTD., Jiangsu Province (CN)

(72) Inventors: Te-Lung TANG, New Taipei City (TW); Chih-Ming WEI, New Taipei City (TW)

(73) Assignees: LEDLINK OPTICS, INC., New Taipei City (TW); YANG ZHOU LEDLINK OPTICS CO., LTD., Jiangsu Province (CN); LEDLINK OPTICS (DONG GUAN) CO., LTD., Guangdong (CN)

(21) Appl. No.: 13/714,672

(22) Filed: Dec. 14, 2012

(51) Int. Cl. F21V 5/04

(52) U.S. Cl. CPC F21V 5/04
USPC 362/335

(57) ABSTRACT

A lens structure of a light emitting diode (LED) is provided, which includes a body. An outer surface of the body is formed by connection of an edge of a light input surface and an edge of a light output surface. A recess is formed convergently on the central part of the light input surface toward the light output surface. A divergent plane is formed on the end position of the recess. The divergent plane is a round surface with a radius of 0.05 mm to 1 mm. The divergence of the central light emitting from the LED is reinforced via the light output surface, and the amount of the central light emitting from the LED is limited by the area of the divergent plane. Accordingly, the difference of luminous intensity between the central part and the edge of the lighting area can be improved, thereby providing effects of uniform illumination.

### BACKGROUND OF THE INVENTION

1. Field of the Invention

The present invention relates to an optical lens, and more particularly to a lens structure of a light emitting diode (LED) that can change the original light emission angle, the distribution of luminous intensity and the distribution of illuminance using the theory of secondary optical refraction, to adjust the distribution of illuminance in the lighting area, and thus promote the adaptability of LEDs in the various fields of application.

2. Description of the Related Art

Light emitting diodes (LED) having characteristics of low power consumption, high efficiency and long lifetime are very popular in the whole market of illumination products. All of a sudden, LEDs are mainly in place of traditional light sources and used widely in lighting equipment, such as backlight modules of display devices, advertising billboards, streetlamps, patio lights or desk lamps. However, the divergence angle of the LED light is typically only about 120° resulting in smaller lighting areas compared with traditional light sources and affecting the effects of illumination of applied lighting equipment. Additionally, the light sources from LEDs are mostly concentrated in the central part, such that the light sources from the central part has stronger intensity of radiation, and thus the difference of luminance therebetween is too large to achieve the effect of uniform illumination. In order to improve the foregoing problems, an LED lighting device mostly has an optical lens to adjust the direction of the light path of the light source from the LED light source via theory of secondary optics of the optical lens, that is, the illuminance of the original LED light source, light emission angles and uniformity of illuminated light need to be improved to create a variety of better adaptable arrangement of light shapes, thereby providing optimal illumination conditions.

Also, due to the trend of microminiaturization of devices, or the market demand of highly uniform light, high illuminance and large lighting areas, single LED light devices may have a plurality of LEDs mounted therein, and each of the LEDs has an optical lens. Thus, the structural designs and volumes of the optical lenses are limited, and the secondary optical performance created by the optical lenses is also affected, such that the LED lighting devices cannot provide optimal illumination conditions. Accordingly, the problem of how to further use the theory of secondary optical refraction and reflection to promote function of adjusting light path of the optical lenses is urgent to be solved in this art.

### SUMMARY OF THE INVENTION

Therefore, the primary objective of the present invention is to provide a lens structure of a light emitting diode, adaptable for backlight modules of liquid crystal display devices, or for other lighting equipment, in order to improve global illuminance of lighting areas.

To achieve the foregoing objective, a lens structure of a light emitting diode in accordance with the present invention is provided, comprising a body having an outer surface formed by connection of an edge of a light input surface and an edge of a light output surface, characterized by:
a recess formed convergently on the central part of the light input surface toward the light output surface; and
a divergent plane formed on the end position of the recess and being a round surface with a radius of R, wherein R is represented as 0.05 mm ≦R≦1 mm.

In order to project illumination amplitude of light shapes evenly, the recess is formed convergently on the central part of the light output surface toward the divergent plane to further diverge the central light emitting from the light emitting diode through secondary optical refraction.

Preferably, the light input surface has a plurality of circular relief structures, and the circular structures are formed divergently around the center of the light output surface. The rest part of the light input surface excluding the central part with the recess has a plurality of gibbous structures or a matte surface structure formed thereof, in order to strengthen divergence of the light emitting from the light emitting diode and thus improve the light uniformity. Furthermore, the lens structure of a light emitting diode also has three convexes, which are formed on the light input surface for corresponding to a base to attach mutually.

### BRIEF DESCRIPTION OF THE DRAWINGS

FIG. 1 is a perspective view of an embodiment of a lens structure of light emitting diode in accordance with the present invention;

FIG. 2 is a schematic view of light tracks of an embodiment of a lens structure of light emitting diode in accordance with the present invention;

FIG. 3 is an irradiance pattern of light tracks of an embodiment of a lens structure of light emitting diode in accordance with the present invention;

FIG. 4 is a schematic view of light tracks of another embodiment of a lens structure of light emitting diode in accordance with the present invention;

FIG. 5 is an irradiance pattern of light tracks of another embodiment of a lens structure of light emitting diode in accordance with the present invention;

FIG. 6 is another irradiance pattern of light tracks of another embodiment of a lens structure of light emitting diode in accordance with the present invention;

FIG. 7 is a further irradiance pattern of light tracks of another embodiment of a lens structure of light emitting diode in accordance with the present invention;

FIG. 8 is a perspective view of a further embodiment of a lens structure of light emitting diode in accordance with the present invention; and

FIG. 9 is a section view of yet another embodiment of a lens structure of light emitting diode in accordance with the present invention.

### DETAILED DESCRIPTION OF THE PREFERRED EMBODIMENTS

The technical contents of the present invention will become apparent with the detailed description of preferred embodiments and the illustration of related drawings as follows.

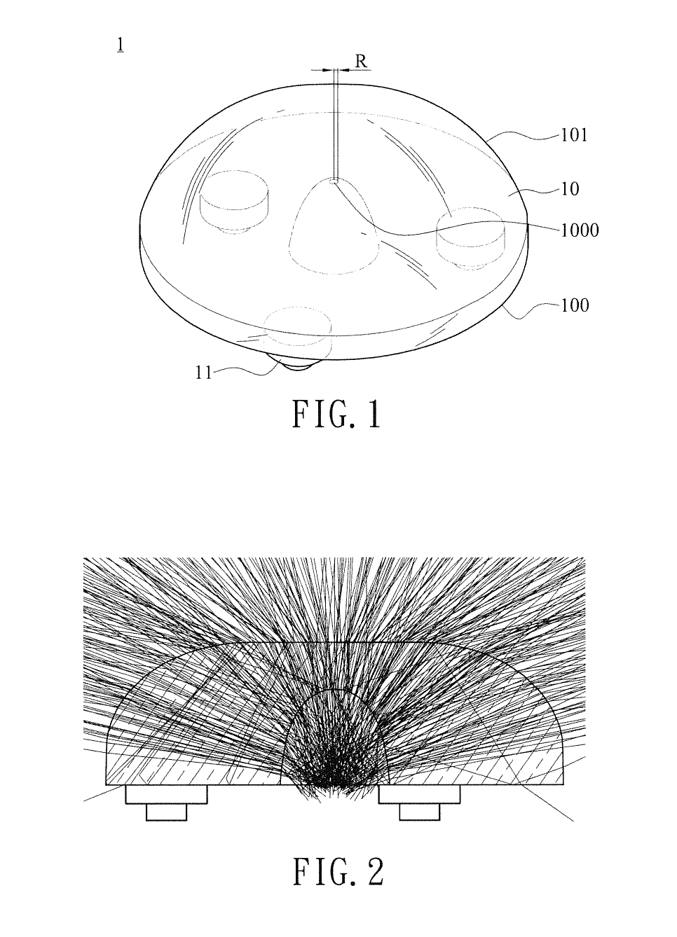

With reference to FIG. 1 for a perspective view of a first embodiment of a lens structure of light emitting diode in accordance with the present invention. Taking a backlight module of a display device as an example, as shown in FIG. 1, the lens of a light emitting diode 1 is used to combine with a light emitting diode (not shown) and then to be applied as a backlight source. The lens structure of the light emitting diode 1 has a body 10 and a least one convex 11. The body 10 has an outer surface formed by connection of an edge of a light input surface 100 and an edge of a light output surface 101. A recess is formed on the central part of the light input surface 100 toward the light output surface 101 for receiving the light emitting diode, and the recess can be formed convergently from an arc surface or a flat surface of the light input surface 100 toward the light output surface, and the end position of the recess is a round divergent plane 1000, such that the recess is a conical cylinder space structure in outline, and the divergent plane 1000 has a radius of R represented as: 0.05 mm ≦R≦1 mm. Additionally, the edge of the light input surface 100 has the convexes 11 mounted thereon for corresponding to a base (not shown) to attach mutually, in order to be easily used for assembling of lighting devices.

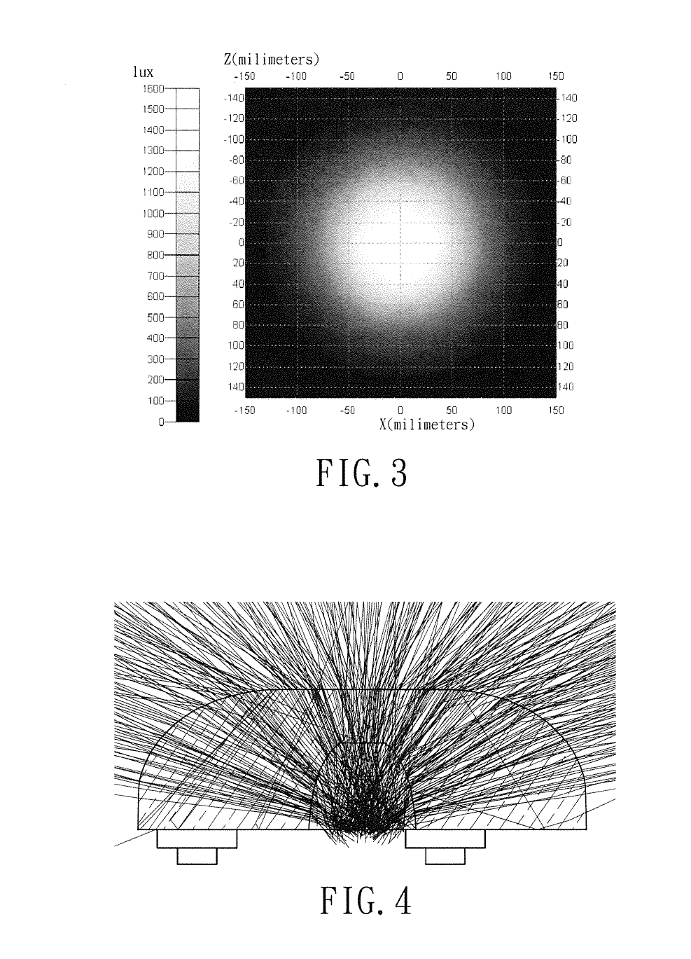

As the radius R of the divergent plane 1000 is 0.05 mm, as shown in FIGS. 2 and 3 for a schematic view and an irradiance pattern respectively of light tracks of an embodiment of a lens structure of a light emitting diode in accordance with the present invention. The central light emitting from the light emitting diode is restricted by the area of the divergent plane 1000. Only part of light beams income through the divergent plane 1000 and then emit from the light output surface 101, the rest part of light beams are blocked by the wall of the recess and then produce optical refraction, such that the light paths shift and further scatter part of the central emitting from the light emitting diode to achieve effects of illumination with uniform intensity.

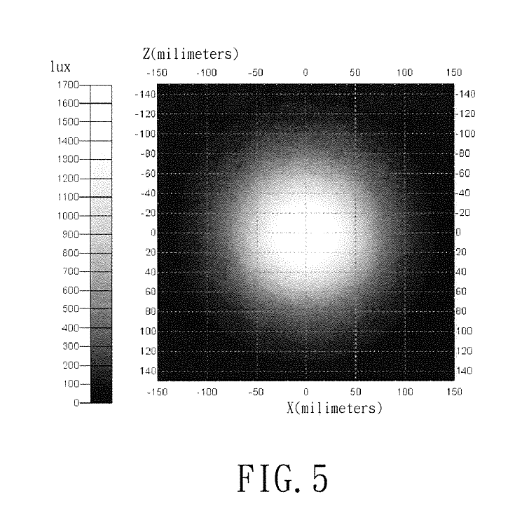

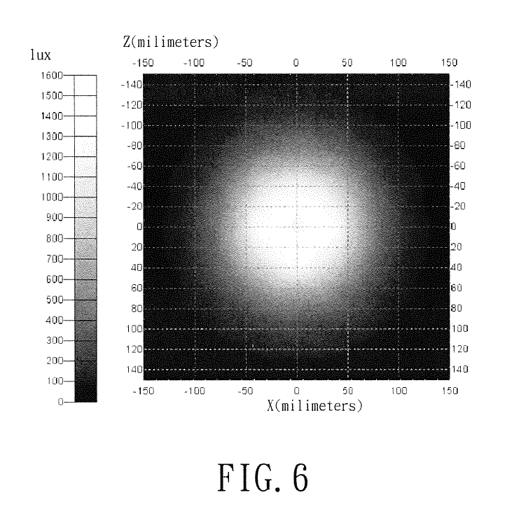

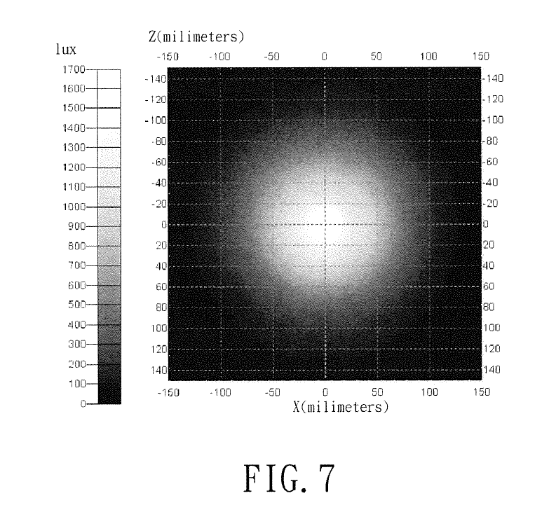

Alternatively, as shown in FIGS. 4 and 5 for a schematic view and an irradiance pattern respectively of light tracks of another embodiment of a lens structure of a light emitting diode in accordance with the present invention. As the radius R of the divergent plane 1000 is 1 mm, the area of the divergent plane 1000 of the lens structure of the light emitting diode is larger, relatively, the quantity of light beams emitting from the central part of the light output surface 101 increases. As such, compared with the smaller radius R of 0.05 mm, the divergent plane 1000 with larger radius such as of 1 mm, can achieve effects of smaller lighting area but stronger average illuminance. Accordingly, since the lens structure of the light emitting diode 1 exclude the divergent plane 1000 with too small radius causing the light beams in the central lighting area are too divergent as shown in FIG. 6, such as smaller than the critical value of 0.05 mm, or with too large radius causing the light beams in the central lighting area are too convergent as shown in FIG. 7, such as larger than the critical value of 1 mm, therefore the original light paths can be improved to achieve optimal effects of uniform illumination.

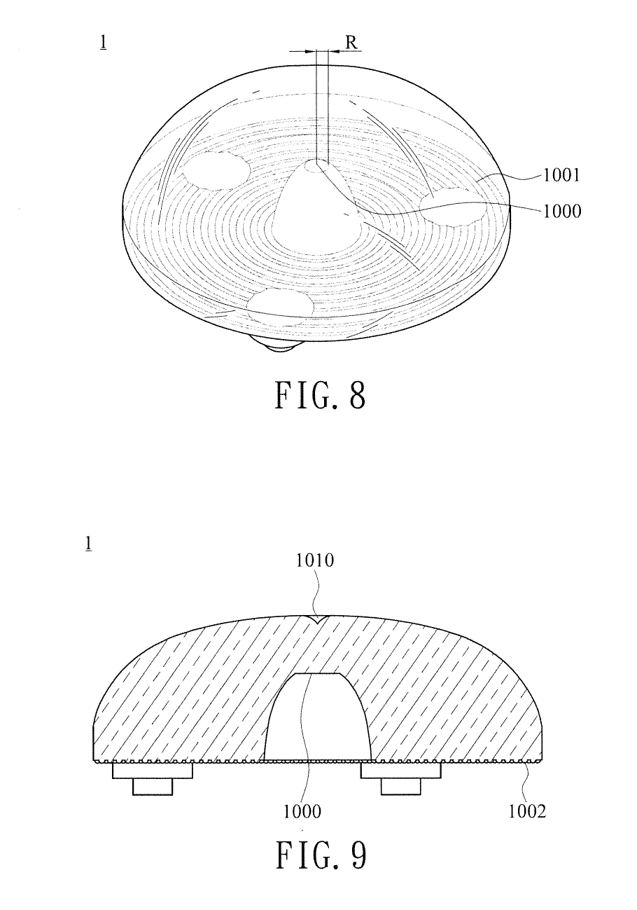

Besides, for projecting the illumination amplitude of light shapes evenly, the lens structure of the light emitting diode 1 is further shown in FIGS. 8 and 9 for a perspective view of a further embodiment and a section view of yet another embodiment respectively of a lens structure of light emitting diode in accordance with the present invention. A cavity 1010 is formed convergently on the central part of the light output surface 101 toward the divergent plane 1000, since the cavity 1010 has a convergent end with an acute angle, the central light emitting from the light emitting diode further diverges using theory of secondary optical refraction. Simultaneously, the light input surface 100 has a plurality of circular relief structures 1001, and the circular relief structures 1001 are formed divergently around the central part of the light output surface 101; however, the illustrations above are just for exemplifications, not limitations. The rest part of the light input surface 100, which excludes the central part with a recess formed convergently, can also be a matte surface structure or have a plurality of gibbous structures 1002 mounted thereon, thereby strengthening divergence of the light emitting from the light emitting diode and thus improve the light uniformity and the quality of illumination

What is claimed is:

1. A lens structure of a light emitting diode comprising a body having an outer surface formed by connection of an edge of a light input surface and an edge of a light output surface, characterized by:
a recess formed convergently on the central part of the light input surface toward the light output surface; and
a divergent plane formed on an end position of the recess and being a round surface with a radius of R, wherein R is represented as 0.05 mm ≦R≦1 mm.

2. The lens structure of the light emitting diode as claimed in claim 1, characterized in that the light input surface has a plurality of circular relief structures, and the circular relief structures are formed divergently around the central part of the light output surface.

3. The lens structure of the light emitting diode as claimed in claim 1, characterized in that the light input surface has a plurality of gibbous structures formed in the rest part thereof.

4. The lens structure of the light emitting diode as claimed in claim 1, characterized in that the rest part of the light input surface is matte surface structure.

5. The lens structure of the light emitting diode as claimed in claim 1, further characterized by three convexes formed on the light input surface for corresponding to a base to attach mutually.

6. The lens structure of the light emitting diode as claimed in claim 1, characterized in that the light output surface has a cavity formed convergently on the central part of the light output surface toward the divergent plane.

7. The lens structure of the light emitting diode as claimed in claim 6, characterized in that the light input surface has a plurality of circular relief structures, and the circular relief structures are formed divergently around the central part of the light output surface.

8. The lens structure of the light emitting diode as claimed in claim 6, characterized in that the light input surface has a plurality of gibbous structures formed in the rest part thereof.

9. The lens structure of the light emitting diode as claimed in claim 6, characterized in that the rest part of the light input surface is matte surface structure.

10. The lens structure of the light emitting diode as claimed in claim 6, further characterized by three convexes formed on the light input surface for corresponding to a base to attach mutually.
